(19) United States
(12) Patent Application Publication
(10) Pub. No.: US 2026/0171063 A1
(43) Pub. Date: Jun. 18, 2026

(54) VEHICLE SOUND PROCESSING DEVICE AND METHOD

(71) Applicants: HYUNDAI MOTOR COMPANY, Seoul (KR); KIA CORPORATION, Seoul (KR)

(72) Inventor: Seokhoon Ryu, Hwaseong-si (KR)

(73) Assignees: HYUNDAI MOTOR COMPANY, Seoul (KR); KIA CORPORATION, Seoul (KR)

(21) Appl. No.: 19/233,960

(22) Filed: Jun. 10, 2025

(30) Foreign Application Priority Data
Dec. 13, 2024 (KR) 10-2024-0185998

(51) Int. Cl. G10K 11/178

(52) U.S. Cl. CPC G10K 11/17815; G10K 11/17817; G10K 2210/12; G10K 2210/1282; G10K 2210/129; G10K 2210/3028; G10K 2210/3216; G10K 2210/3226; G10K 2210/505

(57) ABSTRACT

A vehicle sound processing device includes a microphone configured to detect a sound wave signal including a voice signal, a road noise signal, and a media output signal in a vehicle. The vehicle sound processing device also includes a sensor unit installed in the vehicle to measure a vibration signal. The vehicle sound processing device additionally includes a processor configured to determine road surface noise using the voice signal and the vibration signal and determine a first sound wave correction signal by removing the road surface noise from the sound wave signal. The processor is also configured to determine a second sound wave correction signal by removing the media output signal from the first sound wave correction signal using source information of the media output signal.

### CROSS-REFERENCE TO RELATED APPLICATION(S)

This application claims the benefit of and priority to Korean Patent Application No. 10-2024-0185998, filed on Dec. 13, 2024, the entire contents of which are hereby incorporated herein by reference.

### BACKGROUND

### 1. Technical Field

The present disclosure relates to a vehicle sound processing device and method.

### 2. Discussion of Related Art

When driving a vehicle, various noises may be transmitted to occupants. Due to external noises (e.g., road noise, wind noise, etc.) or in-vehicle media noise (e.g., music, a video, etc.), it is sometimes difficult for occupants to hear and understand each other clearly. This problem is especially evident when driving on highways or in congested urban areas.

Additionally, if the noise is loud, it may be difficult for a driver to concentrate on a conversation or a vehicle situation, and as an effort to hear a conversation is increased, fatigue may be increased, which may affect safe driving.

### SUMMARY

Embodiments of the present disclosure provide a vehicle sound processing device and method capable of efficiently removing road surface noise and a media output signal from a sound wave signal detected in a vehicle.

Embodiments of the present disclosure provide a vehicle sound processing device and method capable of transmitting only a clear audio signal.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a vehicle sound processing device is provided. The vehicle sound processing device includes a microphone configured to detect a sound wave signal including a voice signal, a road noise signal, and a media output signal in a vehicle. The vehicle sound processing device also includes a sensor unit configured to measure a vibration signal in the vehicle. The vehicle sound processing device further includes a processor configured to determine road surface noise using the voice signal and the vibration signal and determine a first sound wave correction signal by removing the road surface noise from the sound wave signal The processor is additionally configured to determine a second sound wave correction signal by removing the media output signal from the first sound wave correction signal using source information of the media output signal.

The processor may be configured to generate first error information based on the sound wave signal and the vibration signal and generate a first cancellation signal corresponding to the vibration signal using a first filter that is updated according to the first error information.

The processor may be configured to determine the first error information according to a first sound path along which the first cancellation signal is input to an amplifier of the vehicle and the first cancellation signal reaches the first error microphone installed around a person who is speaking.

The processor may be configured to determine the first sound wave correction signal by reflecting the first cancellation signal in the sound wave signal.

The processor may be configured to generate second error information based on the first sound wave correction signal and the source information of the media output signal and generate a second cancellation signal corresponding to the media output signal using a second filter that is updated according to the second error information.

The processor may be configured to determine the second error information according to a second sound path along which the second cancellation signal is input to an amplifier of the vehicle and the second cancellation signal reaches a second error microphone installed around a listener.

The processor may be configured to determine the second sound wave correction signal by reflecting the second cancellation signal in the first sound wave correction signal.

The processor may further be configured to extract an echo signal from the second sound wave correction signal and determine a third sound wave correction signal by removing the echo signal from the second sound wave correction signal.

The vehicle sound processing device may further include an amplifier configured to amplify the third sound wave correction signal.

The vehicle sound processing device may further include an audio output unit configured to output the amplified third sound wave correction signal.

According to another aspect of the present disclosure, a vehicle sound processing method is provided. The vehicle sound processing method includes detecting, by a microphone, a sound wave signal including a voice signal, a road noise signal, and a media output signal in a vehicle. The vehicle sound processing method also includes measuring, by a sensor unit, a vibration signal in the vehicle. The vehicle sound processing method additionally includes determining, by a processor, road surface noise using the voice signal and the vibration signal. The vehicle sound processing method further includes determining, by the processor, a first sound wave correction signal by removing the road surface noise from the sound wave signal. The vehicle sound processing method also includes determining, by the processor, a second sound wave correction signal by removing the media output signal from the first sound wave correction signal using source information of the media output signal.

Determining the first sound wave correction signal may include generating first error information based on the sound wave signal and the vibration signal, and generating a first cancellation signal corresponding to the vibration signal using a first filter that is updated according to the first error information.

Generating the first error information may include determining the first error information according to a first sound path along which the first cancellation signal is input to an amplifier of the vehicle and the first cancellation signal reaches a first error microphone installed around a person who is speaking.

Determining the first sound wave correction signal may include determining the first sound wave correction signal by reflecting the first cancellation signal in the sound wave signal.

Determining the second sound wave correction signal may include generating second error information based on the first sound wave correction signal and the source information of the media output signal, and generating a second cancellation signal corresponding to the media output signal using a second filter that is updated according to the second error information.

Generating the second error information may include determining the second error information according to a second sound path along which the second cancellation signal is input to an amplifier of the vehicle and the second cancellation signal reaches a second error microphone installed around a listener.

Determining the second sound wave correction signal may include determining the second sound wave correction signal by reflecting the second cancellation signal in the first sound wave correction signal.

The vehicle sound processing method may further include extracting, by the processor, an echo signal from the second sound wave correction signal, and determining, by the processor, a third sound wave correction signal by removing the echo signal from the second sound wave correction signal.

The vehicle sound processing method may further include amplifying, by the processor, the third sound wave correction signal.

The vehicle sound processing method may further include outputting, by an audio output device, the amplified third sound wave correction signal.

### BRIEF DESCRIPTION OF THE DRAWINGS

The above and other objects, features, and advantages of the present disclosure should become more apparent to those of ordinary skill in the art from the following detailed description taken in conjunction with the accompanying drawings, in which:

FIG. 1 is a diagram illustrating a vehicle communicating with another device, according to an embodiment of the present disclosure;

FIG. 2 is a diagram showing modules of a vehicle according to an embodiment of the present disclosure;

FIG. 3 is a block diagram of a vehicle sound processing device according to an embodiment of the present disclosure;

FIG. 4 is a diagram for explaining the operation of the vehicle sound processing device according to an embodiment of the present disclosure;

FIG. 5 is a conceptual diagram of the vehicle sound processing device according to an embodiment of the present disclosure; and

FIG. 6 is a conceptual diagram of a vehicle sound processing method according to an embodiment of the present disclosure.

### DETAILED DESCRIPTION

Hereinafter, embodiments of the present disclosure are described in detail with reference to the accompanying drawings.

However, the technical spirit of the present disclosure is not limited to the described embodiments. Rather, the present disclosure may be implemented in various different forms. For example, one or more of the components described herein may be selectively combined and/or substituted without departing from the scope of the technical spirit of the present disclosure.

In addition, terms (including technical and scientific terms) used in the following description should be interpreted as meanings that are generally understood by those having ordinary skill in the art to which the present disclosure pertains unless explicitly specifically defined and described herein. Further, the meanings of the commonly used terms, such as terms defined in a dictionary, should be interpreted in consideration of contextual meanings of the related art.

In addition, the terms used in the following description are for describing the embodiments and are not intended to limit the present disclosure.

In the specification, a singular form may include a plural form unless the context clearly dictates otherwise, and when described as “at least one (or one or more) of A, B, and C,” it may include one or more of all possible combinations of A, B, and/or C.

In addition, terms such as first, second, A, B, (a), and (b) may be used to describe components of the embodiments of the present disclosure.

These terms are only for the purpose of distinguishing one component from another component, and the nature, sequence, order, etc. of the corresponding components are not limited by these terms.

In addition, when a first component is described as being “connected,” “coupled,” or “joined” to or with a second component, it may include not only a case in which the first component is directly connected, coupled, or joined to or with the second component, but also a case in which the first component is “connected,” “coupled,” or “joined” to or with the second component with one or more other components present between the first component and the second component.

In addition, when a first component is described as being formed or disposed on “on (above) or below (under)” a second component, “on (above)” or “below (under)” may include not only a case in which two components are in direct contact with each other, but also a case in which one or more other components are formed or disposed between the two components. In addition, when expressed as “on (above) or below (under),” it may include the meaning of not only an upward direction but also a downward direction based on one component.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings. In the following description, the same or corresponding components are denoted by the same reference numeral regardless of the reference numerals, and overlapping descriptions thereof are omitted.

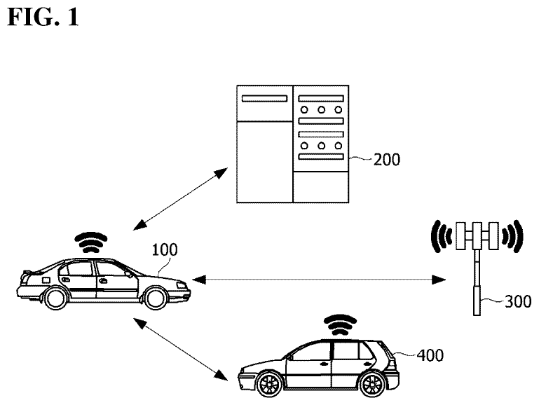

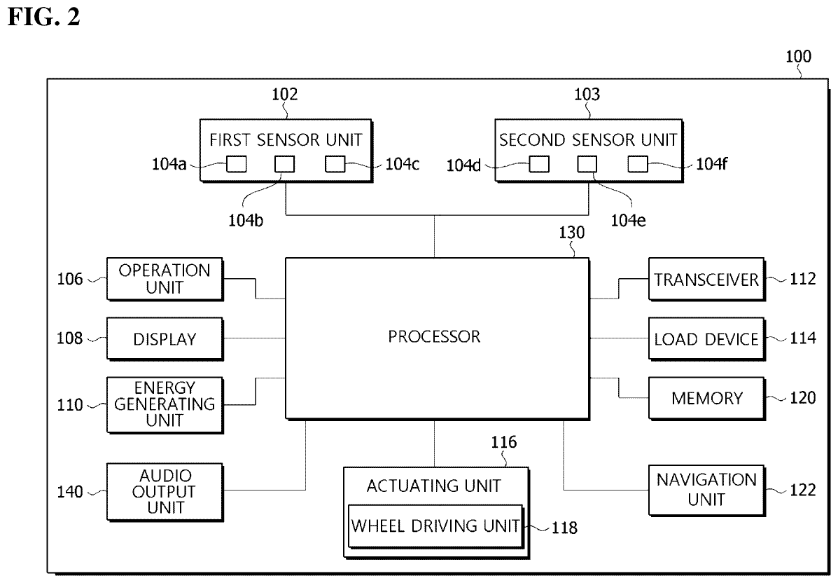

Hereinafter, a vehicle according to an embodiment is described with reference to FIGS. 1 and 2. FIG. 1 is a diagram illustrating a vehicle communicating with another device to transmit and receive data, according to an embodiment.

Referring to FIG. 1, a vehicle 100 may be driven based on electrical energy or fossil energy. In the case of electrical energy, the vehicle 100 may be, for example, an exclusively battery-based vehicle driven only by a high-voltage battery or may employ a gas-based fuel cell as an energy source. Additionally, the fuel cell may use various types of gases to generate electrical energy. The vehicle 100 may be filled with gas in a liquefied state, for example. One example of the gas may be hydrogen. However, the present disclosure is not limited thereto and various gases may be applied. In the case of fossil energy, the vehicle 100 is driven based on fuel such as gasoline, diesel, or liquefied gas, and may be equipped with an internal combustion engine that drives an actuating unit (e.g., actuating unit 116 of FIG. 2) by combustion of the fuel. The engine may be included in an energy generating unit (e.g., energy generating unit 110 of FIG. 2) in terms of providing driving rotational power for wheels to a wheel driving unit 118. As another example, the vehicle 100 may drive the actuating unit by selectively utilizing energy from a fossil fuel-based internal combustion engine and an electric battery, and may be a hybrid type vehicle.

The vehicle 100 may refer to a movable device. The vehicle 100 may be a ground vehicle that travels on the ground, such as a typical passenger or commercial vehicle, a purpose built vehicle (PBV), etc. The vehicle 100 may be a four-wheeled vehicle, such as a passenger car, an SUV, or a small truck, or a vehicle with more than four wheels, such as a bus, a large truck, a container transport vehicle, or a heavy equipment vehicle. Here, the ground vehicle may be referred to as any vehicle including a vehicle that moves underground as well as a vehicle that moves over land. The vehicle 100 may be a robot (e.g., as a means of transportation), and the robot may be moved using wheels, tracks, or other movement modules. Although the present disclosure primarily describes ground mobility devices such as ground vehicles, the present disclosure is also applicable to air mobility devices such as AAMs, aircraft, etc., or water mobility devices such as ships, submarines, and the like, unless it contradicts the present disclosure.

The vehicle 100 may be controlled and driven by autonomous driving, and the autonomous driving may be implemented as semi-autonomous driving or fully autonomous driving. Fully autonomous driving may be provided as autonomous movement in which a processor (e.g., processor 130 of FIG. 2) of the vehicle 100 is fully in control without user intervention, even when the driving situation is uncertain. Semi-autonomous driving may be provided as autonomous movement that requires driver intervention depending on specific driving situations. The semi-autonomous driving may be implemented in such a manner that the processor deactivates the autonomous driving and transfers control to the user when the above situation occurs, allowing the user to perform manual driving. According to the levels of autonomous driving defined by the Society of Automotive Engineers (SAE), the semi-autonomous driving may correspond to autonomous driving levels 1-4, and the fully autonomous driving may correspond to level 5.

The vehicle 100 may communicate with other devices 200 and 300 or another vehicle 400. Examples of the other devices may include a server 200 that supports various controls, state management, and driving of the vehicle 100, an intelligent transportation system (ITS) device 300 for receiving information from an ITS, various types of user devices, etc. The server 200 may be, for example, an external device operated by a vehicle manufacturer or provided to service autonomous driving and may receive connected data of the vehicle 100 or transmit data required for autonomous driving. The server 200 may transmit various types of information and software modules, which are used for controlling the vehicle 100, to the vehicle 100 in response to requests and data transmitted from the vehicle 100 and the user device to support autonomous driving and various services of the vehicle 100.

The ITS device 300 may be, for example, a road side unit (RSU), and the ITS device 300 may assist manual driving of the user or support autonomous driving of the vehicle 100 by exchanging vehicle recognition data, driving control and state data, environmental data around the vehicle, map data, etc. with the vehicle 100 through V2I communication. The vehicle 100 may support manual driving or autonomous driving by exchanging the data with another vehicle 400 through V2V communication.

The vehicle 100 may communicate with another vehicle and/or another device based on cellular communication, wireless access in vehicular environment (WAVE) communication, dedicated short range communication (DSRC) or short-range communication, or another communication method.

For example, the vehicle 100 may use a cellular communication network such as Long Term Evolution (LTE), 5G, a Wi-Fi communication network, a WAVE communication network, etc, for communication with the server 200, the ITS device 300, or another vehicle 400. As another example, Direct Short Range Communication (DSRC) or the like used in the vehicle 100 may also be used for communication between vehicles. The communication method between the vehicle 100 and the server 200, the ITS device 300, another vehicle 400, or the user device is not limited to the above-described examples.

FIG. 2 is a diagram showing modules constituting the vehicle 100 of FIG. 1, according to one embodiment of the present disclosure.

The vehicle 100 may include a sensor unit 102, an operation unit 106, a display 108, a load device 114, and a transceiver 112.

The sensor unit 102 may be equipped with various types of sensors or detectors for detecting various states and situations occurring in an external environment, an internal system, a user operation, and a boarding space of the vehicle 100.

For example, the first sensor unit 102 may be equipped with an externally facing camera 104a, a LiDAR sensor 104b, a radar sensor 104c, etc. to recognize dynamic and static objects present outside the vehicle 100. The camera 104a may recognize an external object as an image while the vehicle 100 is in use, generate image data, and transmit the image data to the processor 130. The LiDAR sensor 104b may generate point cloud data as recognized data of the external object and transmit the point cloud data to the processor 130 to generate three-dimensional (3D) spatial information that identifies at least a shape of the external object. The radar sensor 104c may emit radio waves of a specific frequency around the vehicle 100 and generate radar data through the radio waves reflected from the external object to grasp the presence of the external object, and its relative distance, speed, direction, etc. In the present disclosure, it is described that the LiDAR sensor 104b is included, but in other examples, the LiDAR sensor 104b may be omitted.

The first sensor unit 102 may generate object recognition information based on the sensing data. The object recognition information may include information on the presence of an object, information on the position of the object, information on the distance between the vehicle 100 and the object, and information on the relative speed between the vehicle 100 and the object. In the embodiment, the external object may be one of various objects related to the driving of the vehicle 100.

The second sensor unit 103 may be equipped with a positioning sensor 104d, a wheel sensor 104e, and an attitude sensor 104f to check the position, speed, and driving attitude of a host vehicle. The attitude sensor 104f may include a gyro sensor, an angular velocity sensor, an acceleration sensor, etc. The attitude sensor may be an inertial measurement unit (IMU) sensor and may be equipped with a 3-axis accelerometer and a 3-axis gyroscope. The attitude sensor may measure acceleration in a traveling direction x, acceleration in a lateral direction y, and acceleration in a height direction z of the vehicle 100, and the yaw, pitch, and roll as the angular velocity of the vehicle.

The second sensor unit 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire air pressure information, vehicle steering information, vehicle interior temperature information, vehicle interior humidity information, pedal position information, vehicle engine temperature information, etc.

Additionally, the vehicle driving information may include route information. The route information may refer to information generated based on a destination input by a vehicle user through the operation unit 106. The route information may refer to information that indicates a traveling route from a current vehicle position to a destination on map when the destination has been set. When no destination is set, the route information may refer to information including a road on which a host vehicle is currently traveling and a future driving route including the road.

The operation unit 106 may be formed as a module for the user to control driving. For example, the operation unit 106 may include a steering wheel for manual driving, an automatic or manual shift transmission, an accelerator pedal, a brake pedal, etc. The operation unit 106 may further include an interface for enabling or disabling an autonomous driving mode and selecting detailed functions requested by the user so that the user may use an autonomous driving function. The operation unit 106 may be formed as, for example, a hard type interface provided at a predetermined location inside the vehicle 100, or a soft type interface that may be touched on the display 108 to receive various requests related to autonomous driving. Depending on the specifications of the autonomous vehicle, at least one of the steering wheel, the transmission, and the pedal may be omitted. As another example, the operation unit 106 may be equipped with a module for receiving a user's control request for the load device 114 in addition to driving control.

The display 108 may function as a user interface. The processor 130 may cause the display 108 to display information such as the operating state, the control state, the route/traffic information, the remaining energy information of the vehicle 100, and the content requested by a driver. Additionally, the display 108 may be formed as a touch screen capable of detecting a driver's input and receiving a request from the driver to instruct the processor 130.

The load device 114 is mounted on the vehicle 100 and may be a type of non-driving electric device excluding a driving power system such as a wheel driving unit 118. The load device 114 is an auxiliary device that receives electric power from an energy generating unit 110, and may include, for example, an air conditioning system, a lighting system, a seat system, various devices installed in the vehicle 100, etc. In embodiments of the present disclosure, a cooling/heating system that cools or heats at least one of a battery, a fuel cell, an internal combustion engine, an air conditioning system, and a specific portion of the vehicle 100 may be further included.

The transceiver 112 may support mutual communication with a server 200, an ITS device 300, surrounding vehicles 300, etc. The transceiver 112 may include a module that processes, for example, cellular communication, WAVE communication, DSRC communication, etc. In embodiments of the present disclosure, the transceiver 112 may transmit data generated or stored during driving to the server 200 and receive data and software modules transmitted from the server 200. The transceiver 112 may also support communication with an electronic device carried by the occupant inside the vehicle 100. In embodiments of the present disclosure, the vehicle 100 may transmit and receive data utilized in a method according to the present disclosure with the outside through the transceiver 112.

For example, the transceiver 112 may receive traffic signal information from a traffic signal controller and provide the traffic signal information to the processor 130. In addition, the transceiver 112 may receive a control signal from the traffic signal controller and provide the control signal to the processor 130.

Additionally, the vehicle 100 may include the energy generating unit 110 and the actuating unit 116.

The energy generating unit 110 may generate and supply power and electric power used in a driving power system such as the actuating unit 116 and a non-driving power system. The non-driving power system may include, for example, the sensor unit 102, the operation unit 106, the display 108, the load device 114, and the transceiver 112, but is not limited thereto, and may include various components that implement sensing, interface, communication, and convenience functions, excluding components directly involved in driving operations. When the vehicle 100 is driven based on electrical energy, the energy generating unit 110 may be formed as, for example, an electric battery that is charged from the outside, or formed as a combination of an electric battery and a fuel cell that charges the battery. In the case of a combination of an electric battery and a fuel cell, the energy generating unit 110 may include a tank that stores a material used to produce electric power for the fuel cell, such as liquefied hydrogen. When the vehicle 100 is driven based on fossil fuel energy, the energy generating unit 110 may be formed as an internal combustion engine. Additionally, when the vehicle 100 is a hybrid type, the energy generating unit 110 may be provided as a combination of an internal combustion engine and an electric battery.

The actuating unit 116 may be equipped with at least one module that implements a driving operation, and may perform at least one driving operation among longitudinal control such as acceleration/deceleration and lateral control such as steering, according to the user request from the operation unit 106. The actuating unit 116 may be equipped with a wheel driving unit 118, mechanical components for implementing an driving operation in the wheel driving unit 118, and electronic modules to perform the driving operation according to commands from the processor 130 by manual operation of the user or autonomous driving. When the vehicle 100 is operated based on electrical energy, the vehicle 100 may include an assembly for transmitting the requested driving operation to the wheel driving unit 118. When the vehicle 100 is operated based on fossil fuel energy, the actuating unit 116 may be equipped with a transmission and gear module that transmits the power of the internal combustion engine.

The wheel driving unit 118 may include a plurality of wheels, a driving force generation module for generating a driving force and applying or transmitting the driving force to the wheels, a braking module for decelerating the driving of the wheels, and a steering module for implementing lateral control of the wheels. When the vehicle 100 is driven based on electrical energy, the driving force generation module may be formed as a motor assembly that generates a driving force based on electric power output from the electric battery. The braking module of the electric-based vehicle 100 may further have a regenerative braking function.

A navigation unit 122 may provide navigation information. The navigation information may include at least one of map information, set destination information, route information according to a set destination, information on various objects on the route, lane information, or current vehicle position information.

The navigation unit 122 may receive information from an external device through the transceiver unit 112 and may update previously stored information. Depending on the embodiment, the navigation unit 122 may be classified as a sub-component of the operation unit 106.

An audio output unit 140 may convert an electrical signal provided from the processor 130 into an audio signal and output an audio. The audio output unit 140 may include one or more speakers.

Additionally, the vehicle 100 may include a memory 120 and the processor 130.

The memory 120 stores applications and various types of data for controlling the vehicle 100, and may load the applications or read or write data at the request of the processor 130.

The processor 130 may perform overall control of the vehicle 100. The processor 130 may be configured to execute the applications and instructions stored in the memory 120.

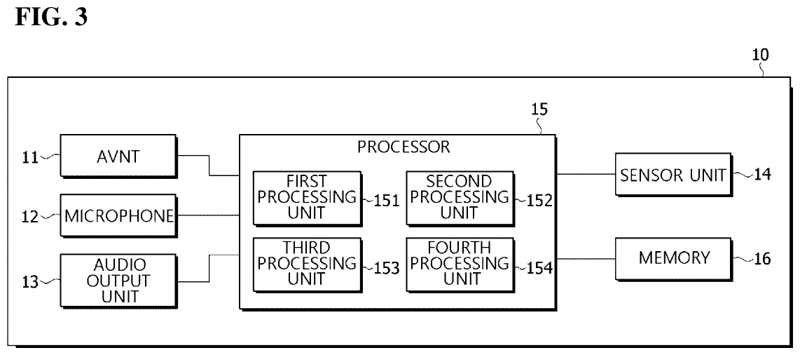

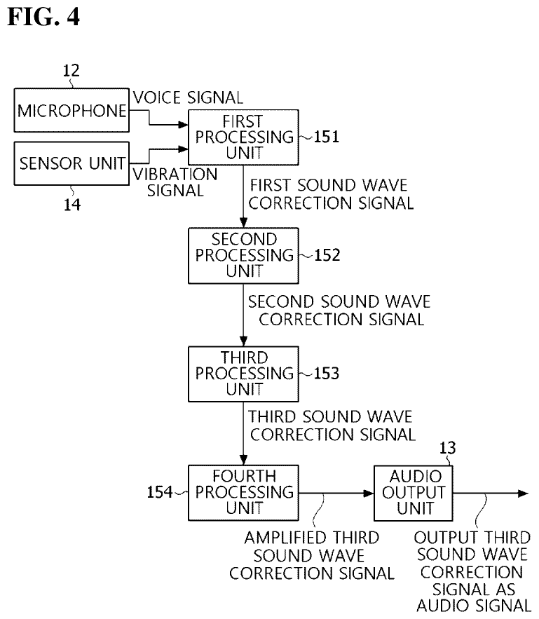

FIG. 3 is a block diagram of a vehicle sound processing device according to an embodiment. FIG. 4 is a diagram for explaining the operation of the vehicle sound processing device according to an embodiment. Referring to FIGS. 3 and 4, a vehicle sound processing device 10 according to an embodiment may include an audio/video/navigation/telecommunication (AVNT) 11, a microphone 12, an audio output unit or device 13, a sensor unit or sensor 14, a processor 15, and a memory 16.

In an embodiment, the processor 15 may include a first processing unit 151, a second processing unit 152, a third processing unit 153, and a fourth processing unit 154. The processor 15 may have the same configuration as the processor 130 of FIG. 2, and the memory 16 may have the same configuration as the memory 120 of FIG. 2, in an embodiment.

The AVNT 11 may be an information and entertainment system in the vehicle. For example, AVNT 11 may be a system that integrates navigation, audio, video, and communication functions. The AVNT 11 may output a message generated by the processor 15 in at least one of a visual manner, an audible manner, or a combination thereof.

The AVNT 11 may refer to a component that provides a hardware interface integrated into a system in the vehicle. The AVNT 11 may perform system control targeting a screen, buttons, and various integrated information and entertainment functions.

The AVNT 11 may be installed in a center or console of the vehicle dashboard and may provide vehicle information and an entertainment interface. The information and entertainment system may include an AM/FM radio, a satellite radio, DVDs/CDs, cassette tapes, USB MP3, dashcams, GPS navigation, Bluetooth, Wi-Fi, etc., and may also provide state information on the vehicle system. In addition, the AVNT 11 may perform functions such as audio control, motion recognition, etc.

The AVNT 11 may include the microphone 12, the audio output unit 13, and the processor 15, but for convenience of explanation, each component is described separately.

The microphone 12 may be installed inside the vehicle to detect a sound wave signal including a voice signal, a road noise signal, and a media output signal.

In an embodiment, the voice signal may refer to a sound signal generated by the speech of a vehicle occupant.

In an embodiment, the road noise signal may refer to ambient noise generated due to the interaction between the road and the tire during vehicle driving, the surrounding environment, and/or the structural characteristics of the vehicle itself. The road noise signal may include contact noise between the tire and the road surface, aerodynamic noise, engine and exhaust system noise, vehicle structural vibration noise, etc.

In the embodiment, the media output signal may refer to various forms of audio content signals reproduced through the audio output unit 13, such as radio, music, navigation guidance, phone calls, and streaming services.

The microphone 12 may be mounted inside the vehicle and receive voice signals, road noise signals, and media output signals detected inside the vehicle. The microphone 12 may be installed at various locations inside the vehicle to receive these voice signals as clearly as possible.

For example, the microphone 12 may be mounted in a headliner of the vehicle. This location is close to the mouth of the occupant to receive a voice efficiently and receive relatively less ambient noise (e.g.: wind noise coming in through the window).

For example, the microphone 12 may be mounted on or near a rearview mirror to collect the voice of the occupant.

For example, the microphone 12 may be disposed in a manner of being integrated into the AVNT 11 of the dashboard.

As the microphone 12, a single microphone, dual microphones, or multiple microphones may be applied.

The single microphone may receive the voice of the driver using only one microphone in the vehicle.

The dual microphones may provide better noise suppression and echo removing performance using two microphones. The dual microphones may be used such that one microphone may collect the voice of the occupant and the other may collect the ambient noise, and then the voice and the noise are compared to remove the noise and extract the voice.

The multiple microphones may use a multiple microphone array to enhance the directionality of sound and selectively receive only the voice coming in a specific direction through beamforming technology.

Error microphones 17 and 18 may be installed inside the vehicle, for example near the head or ear position of the occupants, to measure the noise actually heard by the occupants. The error microphones 17 and 18 may detect residual noise introduced into the vehicle interior to monitor the levels of various noises including road surface noise, engine noise, wind noise, etc.

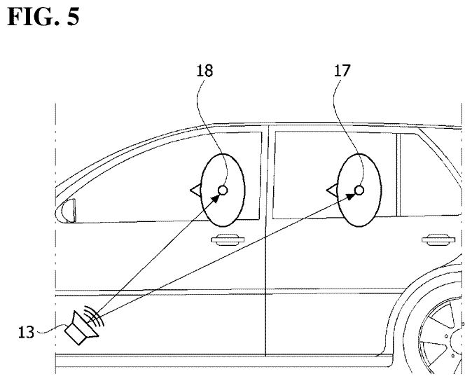

FIG. 5 is a conceptual diagram of the vehicle sound processing device according to an embodiment. Referring to FIGS. 4 and 5, a first error microphone 17 may be a microphone installed around a person who is speaking among the vehicle occupants. For example, the first error microphone 17 may be disposed on the headrest of the vehicle seat where the person who is speaking among the vehicle occupants is seated.

A second error microphone 18 may be a microphone installed around a listener among the vehicle occupants. For example, the second error microphone 18 may be disposed on the headrest of the vehicle seat where the listener among the vehicle occupants is seated.

When a noise cancellation signal (anti-noise) is output from the processor 15 through the audio output unit 13, the error microphones 17 and 18 may check how effectively this signal worked inside the vehicle.

The audio output unit 13 may convert an electrical signal provided from the processor 15 into an audio signal and output an audio. The audio output unit 13 may include one or more speakers, for example.

For example, the audio output unit 13 may convert a third sound wave correction signal determined through the processor 15 into an audio signal and output an audio.

The speakers inside the vehicle may be strategically disposed to provide optimal sound effects. For example, the speakers may be disposed on the dashboard and A-pillars, door panels, a rear deck, headrests, and/or seats.

The sensor unit 14 may be installed in the vehicle to measure a vibration signal.

The sensor unit 14 may be an acceleration sensor and may detect vibrations occurring in a body, an engine mount, a suspension system, etc. of the vehicle.

For example, the sensor unit 14 may be installed around the engine mount of the vehicle to monitor vibrations occurring in the engine in real time.

For example, the sensor unit 14 may be installed on a body frame and a subframe of the vehicle to detect contact vibrations between the tire and the road.

For example, the sensor unit 14 may be installed on the floor of the vehicle to monitor vibrations transmitted to the entire vehicle body.

For example, the sensor unit 14 may be installed in a trunk and a rear subframe to detect vibrations occurring in the rear of the vehicle.

For example, the sensor unit 14 may be installed on an A-pillar, a B-pillar, etc. to monitor structural vibrations of the entire vehicle.

In the embodiment, the sensor unit 14 may have at least one acceleration sensor disposed according to the model, size, and design structure of the vehicle to detect vibrations occurring in various areas of the vehicle and generate vibration signals.

The first processing unit 151 may determine road surface noise using the voice signal and the vibration signal and may determine a first sound wave correction signal by removing the road surface noise from the sound wave signal.

The first processing unit 151 may generate first error information based on the sound wave signal and the vibration signal and may generate a first cancellation signal corresponding to the vibration signal using a first filter that is updated according to the first error information.

The first processing unit 151 may determine the first error information according to a first sound path along which the first cancellation signal is input to an amplifier of the vehicle and the first cancellation signal reaches the first error microphone installed around the person who is speaking.

The first processing unit 151 may determine the first sound wave correction signal by reflecting the first cancellation signal in the sound wave signal.

The first processing unit 151 according to an embodiment may reduce road surface noise by applying an active noise control-road (ANC-R) system that utilizes an acceleration sensor. The first processing unit 151 may use the vibration signal of the acceleration sensor as a reference signal to effectively reduce low-frequency noise generated from the vehicle floor using a filtered-x least mean square (FxLMS) algorithm.

The first processing unit 151 may allow the reference signal input from the sensor 14 to pass through the first sound path to reflect the frequency characteristics inside the vehicle. In the embodiment, the first sound path may be composed of the first processing unit 151, the audio output unit 13, and the first error microphone in that order.

$$\hat{x} ( n ) = \hat{S} ( z ) * x ( n ) \qquad [ Equation 1 ]$$

In Equation 1, Ŝ(z) is a function that models the frequency transfer characteristics of the first sound path, x(n) is the reference signal, and \hat{x}(n) is an estimated reference signal in which the frequency transfer characteristics of the first sound path are reflected.

The first processing unit 151 may generate an estimated reference signal obtained by estimating the degree of reflection of the frequency characteristics inside the vehicle using the vibration signal as the reference signal, as in Equation 1. The first processing unit 151 may use, as reference, a signal obtained by estimating the vibration signal transmitted to the person who is speaking through the first sound path.

The first processing unit 151 may adjust weights based on the estimated reference signal to cancel road noise using the first filter according to the following Equation 2.

$$W ( n + 1 ) = W ( n ) + μ e ( n ) \hat{x} ( n ) \qquad [ Equation 2 ]$$

In Equation 2, W(n) is the first filter, W(n+1) is the updated first filter, μ is a learning rate, and e(n) is the residual noise measured by the first error microphone, which may mean the first error information. The first filter may thus be an adaptive filter and may be updated according to the first error information.

The first processing unit 151 may generate the first cancellation signal by passing the vibration signal detected by the sensor unit 14 through the updated first filter using the vibration signal as the reference signal. The first processing unit 151 may generate the first cancellation signal according to the following Equation 3.

$$y ( n ) = W ( z ) * x ( n ) \qquad [ Equation 3 ]$$

In Equation 3, y(n) is the first cancellation signal, W(z) is the updated first filter, and x(n) is the vibration signal.

The first processing unit 151 may output the first cancellation signal through the audio output unit 13 and may measure the residual noise using the signal input to the first error microphone.

The first error information may be defined according to the following Equation 4.

$$e ( n ) = d ( n ) - y ( n ) \qquad [ Equation 4 ]$$

In Equation 4, e(n) is the first error information, d(n) is the sound wave signal measured through the microphone, and y(n) is the first cancellation signal. The first error information may be used to adaptively update the first filter. The first processing unit 151 may repeat the process of determining the first cancellation signal described above and updating the first filter using the first cancellation signal and the first error information, thereby reducing noise in response to various road conditions (e.g.: a paved road, an unpaved road, etc.) in real time.

The first processing unit 151 may determine the first sound wave correction signal in which the road surface noise is removed from the sound wave signal using the first error information.

The second processing unit 152 may determine a second sound wave correction signal by removing the media output signal from the first sound wave correction signal using source information of the media output signal.

The second processing unit 152 may generate second error information based on the first sound wave correction signal and the source information of the media output signal and may generate a second cancellation signal corresponding to the media output signal using a second filter that is updated according to the second error information.

The second processing unit 152 may determine the second error information according to a second sound path along which the second cancellation signal is input to the amplifier of the vehicle and the second cancellation signal reaches the second error microphone installed around a listener.

The second processing unit 152 may determine the second sound wave correction signal by reflecting the second cancellation signal in the first sound wave correction signal.

In an embodiment, the second processing unit 152 may implement a system that removes a media output signal from the signals input to the microphone based on the media output signal in the vehicle (e.g., music, navigation voice, etc.) using a least mean square (LMS) algorithm.

The microphone inside the vehicle may receive not only the voice of the occupant, but also the media output (music, navigation voice, etc.) reproduced inside the vehicle. Such a media output signal needs to be removed because the media output signal may act as noise during conversations between vehicle occupants.

The second processing unit 152 may perform a process of estimating and removing the media output signal from the first sound wave correction signal based on the source information of the media output signal through the LMS algorithm. The second processing unit 152 may input the source information into the second filter according to the following Equation 5 to determine a media signal reflected inside the vehicle.

$$\hat{d} ( n ) = W ( z ) * s ( n ) \qquad [ Equation 5 ]$$

In Equation 5, \hat{d}(n) is an estimated signal of the media output signal transmitted to the listener through the second sound path, W(z) is the second filter, and s(n) is the source information. The source information is the original data of the media output signal reproduced by the audio output unit 13, and may be acquired by utilizing the data stored in the memory 16.

The second processing unit 152 may generate the second filter to model the second sound path that is connected in the order of the second processing unit 152, the speaker, and the second error microphone as in Equation 5 and may update the second filter.

The second processing unit 152 may determine the second error information by subtracting the estimated media signal from the first sound wave correction signal.

$$e ( n ) = m ( n ) - \hat{d} ( n ) \qquad [ Equation 6 ]$$

In Equation 6, e(n) is the second error information, m(n) is the first sound wave correction signal, and \hat{d}(n) is the estimated media signal. The second processing unit 152 may determine the second error information based on Equation 6, and may determine the second sound wave correction signal in which the media output signal is removed from the first sound wave correction signal using the second error information.

The second processing unit 152 may update the second filter using the second error information.

$$W ( n + 1 ) = W ( n ) + μ e ( n ) s ( n ) \qquad [ Equation 7 ]$$

In Equation 7, W(n) is the first filter, W(n+1) is the updated second filter, u is the learning rate, e(n) is the second error information, and s(n) may refer to the source information.

The second processing unit 152 may remove the media output signal estimated according to the second sound path from the first sound wave correction signal in real time using the second filter that is repeatedly updated through the above-described process and may determine the second sound wave correction signal that includes only the voice signal. The second sound wave correction signal may then be used to generate an audio output signal output signal of an audio output unit in the vehicle. For example, as described in more detail below, the processor 15 may generate a third sound wave correction signal based on the second sound wave correction signal, and may control the audio output unit to output the third sound wave correction signal (or an amplified version of the third sound wave correction signal). As another example, the processor 15 may control the audio output unit to output the second sound wave correction signal (or an amplified version of the second sound wave correction signal). In various embodiments, removing the road surface noise and the media output signal from the sound wave to generate the second sound wave correction signal, improves the quality of the output of the audio output unit (e.g., results in a more stable and accurate output signal of the audio output unit), thereby improving the functioning of the audio output unit, particularly in situations in which external noise and/or in-vehicle media noise are high.

The third processing unit 153 may extract an echo signal from the second sound wave correction signal and may determine the third sound wave correction signal by removing the echo signal from the second sound wave correction signal.

The third processing unit 153 may utilize echo cancellation technology to remove the echo signal from the voice signal collected by the microphone inside the vehicle.

The third processing unit 153 may monitor the second sound wave correction signal output from the audio output unit 13 in real time and may predict the echo signal to be collected by the microphone.

The third processing unit 153 may use an adaptive filter to predict how the speaker sound will be reflected inside the vehicle. The adaptive filter may receive an output signal from the audio output unit 13 and model an echo path according to the vehicle internal environment (e.g., internal structure, reflective surface, etc.). Accordingly, the echo signal, that will be received by the microphone as the sound output from the audio output unit 13 is reflected inside the vehicle, may be predicted and generated in real time.

The microphone inside the vehicle may receive a signal in which the third sound wave correction signal and a reflected echo signal are mixed.

The third processing unit 153 may subtract the predicted echo signal from the signal received by the microphone. This process may be performed through a process of generating an error signal. In an embodiment, the error signal may refer to the remaining signal obtained by subtracting the predicted echo signal from the signal actually input to the microphone. In this error signal, the echo signal is removed from the third sound wave correction signal, leaving only the voice signal.

The third processing unit 153 may continuously adjust the filter using the adaptive filter. The third processing unit 153 may compare the signal collected by the microphone with the error signal and adjust the filter such that the filter may accurately remove the echo. The adaptive filter allows the system to react in real time and optimize echo removing performance even when the noise environment inside the vehicle changes (e.g., road condition change, window opening, vehicle speed change, etc.).

The fourth processing unit 154 may amplify the third sound wave correction signal. For example, the fourth processing unit 154 may amplify the third sound wave correction signal according to a preset gain.

The fourth processing unit 154 may be formed as a linear amplifier. The third sound wave correction signal is connected to an input terminal of a linear amplifier circuit, and the output signal is output from an output terminal of the linear amplifier circuit. The amplifier circuit of the fourth processing unit 154 may include a transistor, a voltage supply device, an output impedance matching circuit, and a feedback circuit.

The transistor of the fourth processing unit 154 may generate the output signal by controlling a voltage or current of the input signal. In an embodiment, the input signal may be amplified by the transistor, and the output signal may be transmitted to an external device through the output impedance matching circuit.

The output impedance matching circuit matches the impedance of the input signal and the impedance of the output device to enable optimal electric power transmission. Additionally, the linear amplifier may improve stability and performance through the feedback circuit.

The feedback circuit of the fourth processing unit 154 may sample the output signal, compare the output signal with the input signal, detect an error, and feed the error back to the transistor to compensate for the sampled error. This allows the audio amplifier to provide stable and accurate output.

The fourth processing unit 154 may apply the third sound wave correction signal to the linear amplifier circuit and amplify the third sound wave correction signal through the transistor to convert the amplified third sound wave correction signal into the output signal. In an embodiment, the stability and performance of the third sound wave correction signal may be improved through the output impedance matching circuit and the feedback circuit, and as a result, the voice signal may be enhanced in the third sound wave correction signal.

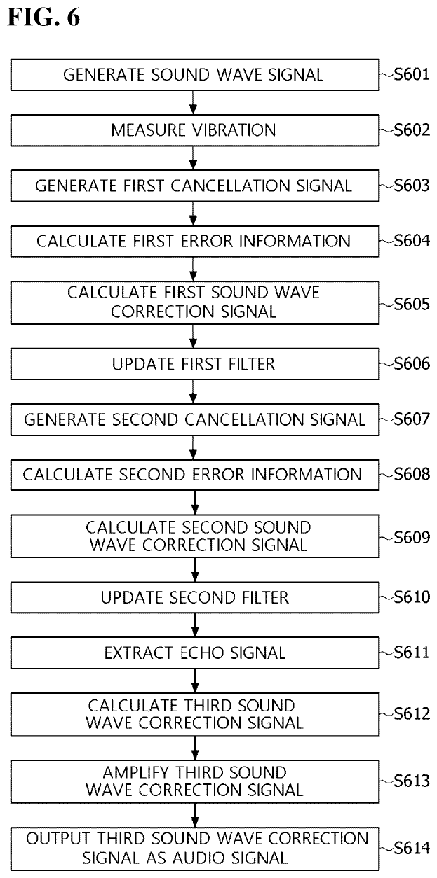

FIG. 6 is a conceptual diagram of a vehicle sound processing method according to an embodiment. Referring to FIG. 6, in an operation S601, the microphone installed in the vehicle detects the voice signal, the road noise signal, and the media output signal to generate the sound wave signal.

In an operation S602, the sensor unit installed in the vehicle measures the vibration signal. The sensor unit may refer to an acceleration sensor.

In an operation S603, the processor generates the first cancellation signal corresponding to the vibration signal using the first filter.

In an operation S604, the processor calculates the first error information according to the first sound path along which the first cancellation signal reaches the first error microphone installed around the person who is speaking.

In an operation S605, the processor calculates the first sound wave correction signal by reflecting the first cancellation signal in the sound wave signal.

In an operation S606, the processor updates the first filter using the first error information. The updated first filter is then utilized to generate the first cancellation signal corresponding to the vibration signal.

In an operation S607, the processor generates the second cancellation signal corresponding to the media output signal using the second filter.

In an operation S608, the processor calculates the second error information according to the second sound path along which the second cancellation signal reaches the second error microphone installed around the listener.

In an operation S609, the processor calculates the second sound wave correction signal by reflecting the second cancellation signal in the first sound wave correction signal.

In an operation S610, the processor updates the second filter using the second error information. The updated second filter is then utilized to generate the second cancellation signal.

In an operation S611, the processor extracts the echo signal from the second sound wave correction signal.

In an operation S612, the processor calculates the third sound wave correction signal by removing the echo signal from the second sound wave correction signal.

In an operation S613, the processor amplifies the third sound wave correction signal.

In an operation S614, the processor controls the audio output unit to output the amplified third sound wave correction signal.

The term “˜ unit” used in the present embodiment may mean a software or hardware component such as a field-programmable gate array (FPGA) or an ASIC, and the “unit” performs certain roles. However, the “˜ unit” is not limited to software or hardware. The “˜ unit” may reside on an addressable storage medium and configured to reproduce one or more processors. Therefore, for example, the “˜ unit” may include components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “˜ units” may be combined into a smaller number of components and “˜ unit” or separated into additional components and “units.” Additionally, the components and “˜ units” may be implemented to reproduce one or more CPUs in a device or a security multimedia card.

The vehicle sound processing device and method according to embodiments may efficiently remove road surface noise and a media output signal from a sound wave signal.

Additionally, only a clear audio signal can be transmitted through the vehicle sound processing device and method.

Additionally, it is possible to extract and transmit a clear audio signal even while a medium reproduces music.

Using these and other techniques described herein, according to embodiments, it is possible to support smooth communication between vehicle occupants.

Although the present disclosure has been described above with reference to example embodiments, those having ordinary skill in the art should understand that the present disclosure may be modified and changed in various ways without departing from the spirit and scope of the present disclosure as defined in the appended claims.

What is claimed is:

1. A vehicle sound processing device comprising:
a microphone configured to detect a sound wave signal including a voice signal, a road noise signal, and a media output signal in a vehicle;
a sensor unit configured to measure a vibration signal in the vehicle; and
a processor configured to:
determine road surface noise using the voice signal and the vibration signal,
determine a first sound wave correction signal by removing the road surface noise from the sound wave signal, and
determine a second sound wave correction signal by removing the media output signal from the first sound wave correction signal using source information of the media output signal.

2. The vehicle sound processing device of claim 1, wherein the processor is configured to:
generate first error information based on the sound wave signal and the vibration signal; and
generate a first cancellation signal corresponding to the vibration signal using a first filter that is updated according to the first error information.

3. The vehicle sound processing device of claim 2, wherein the processor is configured to determine the first error information according to a first sound path along which the first cancellation signal reaches a first error microphone installed around a person who is speaking.

4. The vehicle sound processing device of claim 3, wherein the processor is configured to determine the first sound wave correction signal by reflecting the first cancellation signal in the sound wave signal.

5. The vehicle sound processing device of claim 1, wherein the processor is configured to:
generate second error information based on the first sound wave correction signal and the source information of the media output signal; and
generate a second cancellation signal corresponding to the media output signal using a second filter that is updated according to the second error information.

6. The vehicle sound processing device of claim 5, wherein the processor is configured to determine the second error information according to a second sound path along which the second cancellation signal is input to an amplifier of the vehicle and the second cancellation signal reaches a second error microphone installed around a listener.

7. The vehicle sound processing device of claim 6, wherein the processor is configured to determine the second sound wave correction signal by reflecting the second cancellation signal in the first sound wave correction signal.

8. The vehicle sound processing device of claim 1, the processor is further configured to:
extract an echo signal from the second sound wave correction signal; and
determine a third sound wave correction signal by removing the echo signal from the second sound wave correction signal.

9. The vehicle sound processing device of claim 8, further comprising an amplifier configured to amplify the third sound wave correction signal.

10. The vehicle sound processing device of claim 9, further comprising an audio output unit configured to output the amplified third sound wave correction signal.

11. A vehicle sound processing method comprising:
detecting, by a microphone, a sound wave signal including a voice signal, a road noise signal, and a media output signal in a vehicle;
measuring, by a sensor unit, a vibration signal in the vehicle;
determining, by a processor, road surface noise using the voice signal and the vibration signal;
determining, by the processor, a first sound wave correction signal by removing the road surface noise from the sound wave signal; and
determining, by the processor, a second sound wave correction signal by removing the media output signal from the first sound wave correction signal using source information of the media output signal.

12. The vehicle sound processing method of claim 11, wherein determining the first sound wave correction signal includes:
generating first error information based on the sound wave signal and the vibration signal; and
generating a first cancellation signal corresponding to the vibration signal using a first filter that is updated according to the first error information.

13. The vehicle sound processing method of claim 12, wherein generating the first error information includes determining the first error information according to a first sound path along which the first cancellation signal is input to an amplifier of the vehicle and the first cancellation signal reaches a first error microphone installed around a person who is speaking.

14. The vehicle sound processing method of claim 13, wherein determining the first sound wave correction signal includes determining the first sound wave correction signal by reflecting the first cancellation signal in the sound wave signal.

15. The vehicle sound processing method of claim 11, wherein determining the second sound wave correction signal includes:
generating second error information based on the first sound wave correction signal and the source information of the media output signal; and
generating a second cancellation signal corresponding to the media output signal using a second filter that is updated according to the second error information.

16. The vehicle sound processing method of claim 15, wherein generating the second error information includes determining the second error information according to a second sound path along which the second cancellation signal is input to an amplifier of the vehicle and the second cancellation signal reaches a second error microphone installed around a listener.

17. The vehicle sound processing method of claim 16, wherein determining the second sound wave correction signal includes determining the second sound wave correction signal by reflecting the second cancellation signal in the first sound wave correction signal.

18. The vehicle sound processing method of claim 11, further comprising:
extracting an echo signal from the second sound wave correction signal; and
determining a third sound wave correction signal by removing the echo signal from the second sound wave correction signal.

19. The vehicle sound processing method of claim 18, further comprising amplifying the third sound wave correction signal.

20. The vehicle sound processing method of claim 19, further comprising outputting, by an audio output unit, the amplified third sound wave correction signal.
